(19) United States
(12) Patent Application Publication
(10) Pub. No.: US 2010/0023511 A1
(43) Pub. Date: Jan. 28, 2010

(54) Data File Correlation System And Method

(76) Inventors: Wincenty J. Borodziewicz, (US); Robert E. Davis, (US)

Correspondence Address: PATENT GROUP 2N;JONES DAY, NORTH POINT, 901 LAKESIDE AVENUE, CLEVELAND, OH, 44114, US

(21) Appl. No.: 12/572,757

(22) Filed: Oct. 2, 2009

Related U.S. Application Data
(63) Continuation of application No. 11/525,580, filed on Sep. 22, 2006.
(60) Provisional application No. 60/719,425, filed on Sep. 22, 2005.

(51) Int. Cl. G06F 17/30

(52) U.S. Cl. 707/5; 707/E17.014

(57) ABSTRACT

A method for correlating data from a data source representing a single data file to a data target containing a plurality of data files is provided. The method includes normalizing the data from the data source, such as by removing white space and replacing data strings. One or more data strings are selected for use as preliminary selection criteria. The preliminary selection criteria are then used to search for one or more matches in the normalized data from the data source. If no match is found, one or more data strings are selected for use as secondary selection criteria. A correlation score is calculated if at least one match is found using the preliminary selection criteria.

### RELATED APPLICATIONS

This application claims priority to U.S. Provisional Application 60/719,425, filed Sep. 22, 2005, entitled “INTELLIGENT CLAIM MATCHING SYSTEM AND METHOD,” which is hereby incorporated by reference for all purposes.

### FIELD OF THE INVENTION

This invention relates generally to the field of information handling and more specifically to a system and method for performing matches of source strings and records to target strings and records in a database, where the source or target data can include errors.

### BACKGROUND OF THE INVENTION

Data file processing often requires that the data file has a predetermined field format, predetermined field sizes, predetermined field locations, or other field definition parameters. When data files lack such field definition parameters, such as image data of a document that has been scanned or faxed, it is known to use optical character recognition (OCR) or other processes to associate text-searchable data with the data file. Nevertheless, while such data may be text searchable, it is not associated with any particular field. As such, even if a match is found for a data string in such data, additional manual processing is required to obtain additional data regarding the document.

### SUMMARY OF THE INVENTION

Therefore, a data file correlation system and method are required that allow optically scanned or otherwise unreliable data in a data file to be processed to associate the data file with data in a database.

In accordance with an exemplary embodiment of the present invention, a method for correlating data from a data source representing a single data file to a data target containing a plurality of data files is provided. The method includes normalizing the data from the data source, such as by removing white space and replacing data strings. One or more data strings are selected for use as preliminary selection criteria. The preliminary selection criteria are then used to search for one or more matches in the normalized data from the data source. If no match is found, one or more data strings are selected for use as secondary selection criteria. A correlation score is calculated if at least one match is found using the preliminary selection criteria.

The present invention provides many important technical advantages. One important technical advantage of the present invention is a data file correlation system and method that utilizes predetermined selection criteria for identifying data strings in a data file, based on the significance of the data strings. The data files are initially searched for the most significant data strings, and additional computing resources are only used to perform additional searching when the initial search is unsuccessful.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for data file correlation in accordance with an exemplary embodiment of the present invention;

FIG. 2 is a flow chart of a method for streaming data for data file correlation in accordance with an exemplary embodiment of the present invention;

FIG. 3 is a flow chart of a method for performing matches of given input strings to target data sets in accordance with an exemplary embodiment of the present invention;

FIG. 4 is a flow chart of a method for setting source and target specific parameters for tuning the matching engine in accordance with an exemplary embodiment of the present invention;

FIG. 5 is a flow chart of a method for building selection criteria in accordance with an exemplary embodiment of the present invention;

FIG. 6 is a flow chart of a method for adjusting scores based on adjunct criteria in accordance with an exemplary embodiment of the present invention; and

FIG. 7 is a diagram of a method for determining the relationship between thresholds TH₀ and TH₁ in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

This invention generally comprises a system and method for correlating data by performing matches of source strings from data files to target strings in data files given unreliable source and or target data.

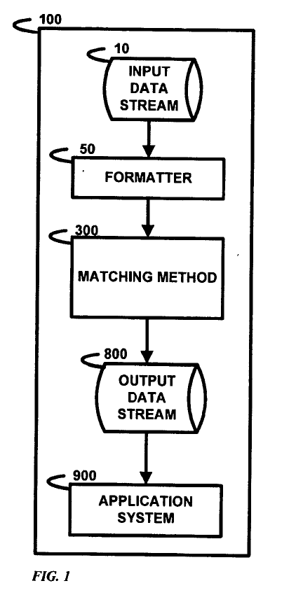

FIG. 1 is a diagram of a system 100 for data file correlation in accordance with an exemplary embodiment of the present invention. System 100 can be implemented in hardware, software, or a suitable combination of hardware and software, and can be one or more software systems operating on a suitable processor, such as a general purpose processing platform. As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Input data stream 10 is formatted by formatter 50. In one exemplary embodiment, formatter 50 normalizes the input data stream 10 from various sources into a common format used for processing by method 300. For example, the input data stream can originate in any format including but not limited to a formatted text file, such as a HIPPA compliant 837 file or a binary file.

Matching method 300 receives the normalized data from formatter 50 and performs selection and filtering of the data based upon predetermined characteristics of data from the source of the data file to generate match data. In one exemplary embodiment, the type of data field, the type of data source, or other suitable criteria can be used to perform selection and filtering of the data. In this exemplary embodiment, a “NAME” field in a data file followed by a data string that matches a stored name can be used for a first level of searching. The “NAME” field data can then be compared to a data source to determine whether a match is found. For example, the input data stream may yield three “NAME” data fields, having values “5TAD3fd,” “Smith” and “Bob.” These data fields can then be used to search the data source, such as to determine whether any are present. If the results of that search are that “5TAD3fd” is not present in a NAME field but that “Smith” and “Bob” are, then a score can be assigned to the search results. Likewise, if there are multiple data records in the data source for which “Smith” and “Bob” are a match, then a lower score can be generated.

If the NAME field search yields no results, or if the score of the results is not high enough, then a second level of searching can be performed, such as by searching for an “ACCOUNT” field followed by a data string that matches characteristics of an account number, such as a predetermined number of numeric characters followed by a predetermined number of alphabetic characters. Multiple strings can be searched at predetermined steps, and scores can be assigned to search results, such as where the scores are compared to a threshold to determine whether a match for the data file has been found in the data source.

The output data stream 800 comprising the matched data, such as using method 300, is received by an application 900 where the matched data can be stored in a data repository or further processed. In one exemplary embodiment, further processing includes sending the matched data to a claims adjudication system that generates forms, notification data or other suitable data based on the match data. In another exemplary embodiment, application 900 can use business rules to validate eligibility information based on the matched data or can perform other suitable processes.

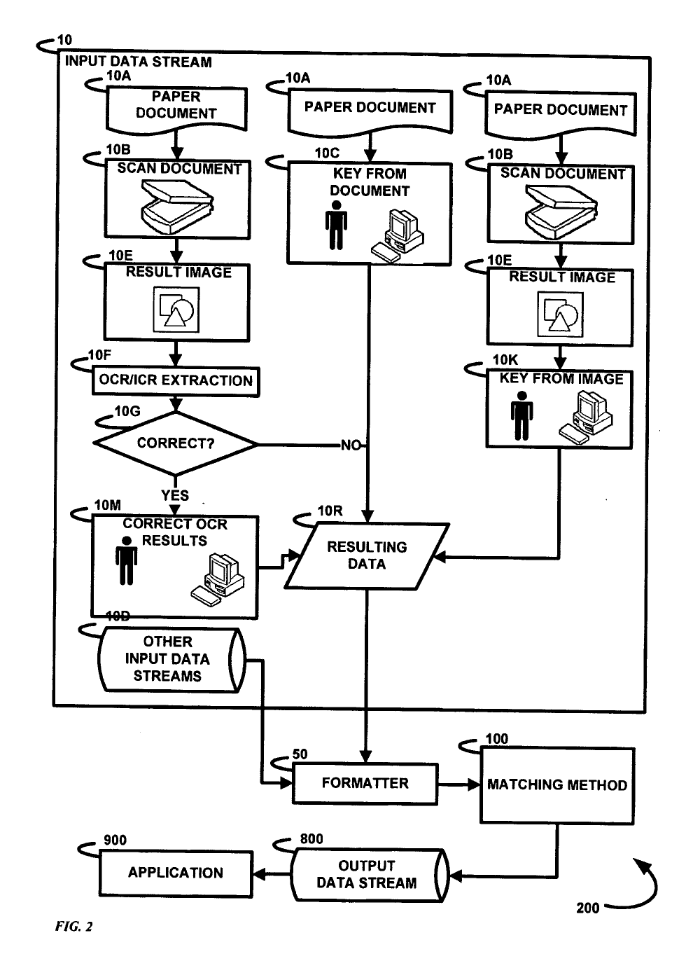

FIG. 2 is a flow chart of a method 200 for streaming data for data file correlation in accordance with an exemplary embodiment of the present invention. Input data stream 10 can originate from a number of different sources, each of which can impart a different level of accuracy and quality due to the data source, the method of input, the method of transport and changing factors not automatically reflected back into the data. As a result, the reliability of the data generated by input data stream 10 can be degraded.

In one exemplary embodiment, data flows can originate with a physical document 10a such as a legal document or medical claim form. The document can be scanned, faxed, or otherwise converted into a data file of image data. Data can also be manually keyed 10c from the document into a data file. For scanned data, optical character recognition or other processes can also be performed such as at 10f, and initial screening of such character recognition processes can be performed at 10g, such as to determine whether those processes are correct. Other input data streams 10d can originate from databases or other data sources. Data streams pass through a formatter 50 to format all data streams, regardless of their origination, into a common format for continued processing.

Documents keyed from an image at 10c have the potential for the introduction of human error, and such manual keying is time consuming and expensive to perform. Documents that are scanned 10b can produce images 10e that are poorer in quality than the original and can result in unavoidable errors in the resulting data 10r when manual keying from image is performed at 10k. Another option is to pass the resulting image 10e through an Optical Character Recognition (OCR) or Intelligent Character Recognition (ICR) engine 10f to extract characters from the image 10e. Depending on the source of the data, OCR engines can have very good to very poor results. These results are dependent on a large number of factors including but not limited to original document quality, document type (e.g., letter or form versus handwritten document), image quality, font type (hand written, OCR optimized font, proportional font), alignment of the data with forms, or other variables. In many situations the accuracy rate of OCR documents is below 50%. Thus, a decision must be made at 10g whether to correct or not correct the data coming out of OCR extraction 10f. The decision to correct the OCR results 10m will likely improve the accuracy of the extracted data relative to the original source document but still holds the potential for human error and can be time consuming. The decision to not correct the OCR extraction results will likely result in the data having more inaccuracies.

Other input data streams 10d include electronic forms such as EDI transmission, databases, and other applications, methods and systems. These data sources can suffer inaccuracies for many of the same reasons as those mentioned above. In many cases data loses accuracy due to aging. Information changes, such as a person's address, but does not get updated into the data source. Thus, information in the data stream may be inaccurate even though the data stream accurately represents what was on the physical document 10a or in the original other input data stream 10d.

Such inaccuracies result in imperfect information from which to perform further processing including data base lookups. In addition, at some point the data must be corrected in order to provide quality end-results.

Input data streams 10 are passed through a formatter 50 to provide a consistent data stream for processing.

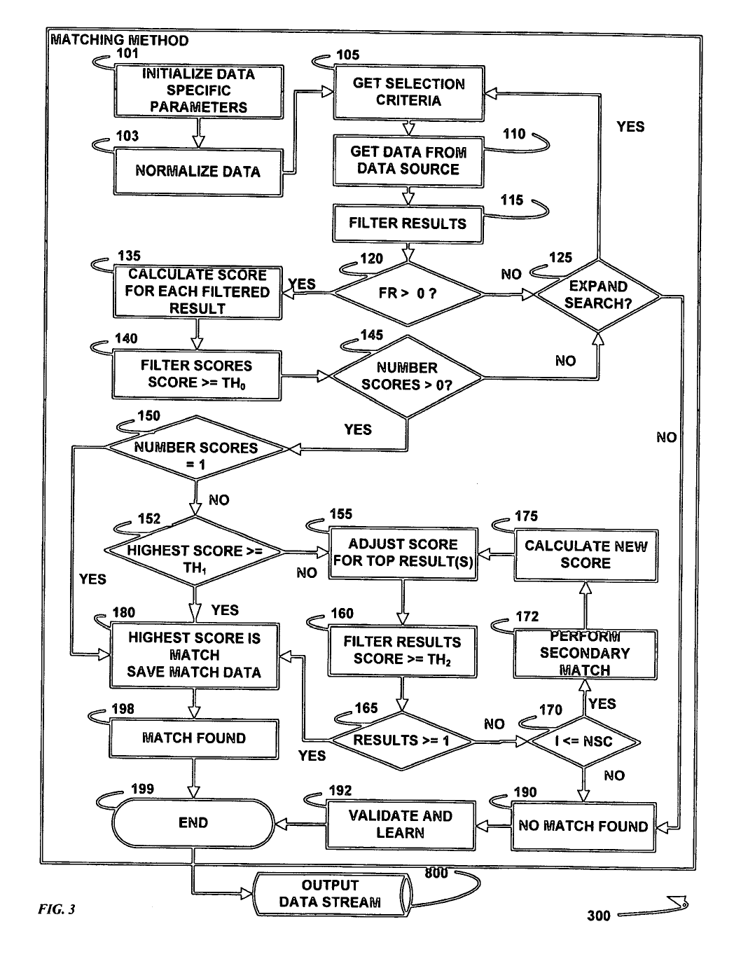

FIG. 3 is a flow chart of a method 300 for performing matches of given input strings to target data sets in accordance with an exemplary embodiment of the present invention. Method 300 allows data from two or more sources to be correlated, such as to identify associated documents or data files based on the contents of the data file.

Method 300 begins at 101, where source-specific parameters are initialized for a data stream. In one exemplary embodiment, the source-specific parameters can include permissible field definitions for data files based on the source of the data file. The method then proceeds to 103 where the data in the data file is normalized. There are a number of techniques used for normalizing data including, but not limited to, consistent casing (uppercase or lower case only), removal of special characters, numeric only, alpha only and/or the removal of whitespace. This normalization is done according to the data type being normalized. For example, a numeric only data stream would be tested and normalized to only include digits. In one exemplary embodiment, data can be normalized to match the permissible field definitions, such as where words such as “services” are converted to an abbreviation such as “SVC,” abbreviations such as HWY are converted to words such as “highway,” or other suitable processes are performed to make data in the data file consistent with data in data files from other sources. The method then proceeds to 105.

At 105, a selection criteria structure is built. In one exemplary embodiment, one or more criteria data strings can be identified that are then compared to an input data string from the data file. In this exemplary embodiment, the matching strings can require matching of all strings, a predetermined number of strings, or at least one string. The criteria used for matching are initially small in number in order to limit the selection results and reduce search time, based on the assumption that the incoming data has a high degree of accuracy. The method then proceeds to 110.

At 110, data is selected from a data source based on a search criteria associated with the data. For example, if a data file containing a medical claim is received from a medical provider and it is being matched to data from an insurance carrier to determine whether the claim is covered, then predetermined data fields from the data file can be used to select data from the data source, such as name data fields, address data fields, identification number data fields, or other suitable data fields. The method then proceeds to 115 where the results are filtered, such as by determining whether any of the data from the data source matched the data in the predetermined data fields from the data file. The method then proceeds to 120.

At 120, it is determined whether data was identified in the filtering process. If no data was identified, the method proceeds to 125 where it is determined whether the search can be expanded, such as whether additional search data fields are available that were not used, in order to reduce the computing time required to process the data file by limiting initial searches to the most likely data fields to yield a match. If it is determined at 125 that the search can be expanded, the method proceeds to 105 where expanded search criteria are built and the method returns to 110. The expanded search criteria built in 105 can include additional fields, fuzzy search techniques (such as those based on string edit distances, soundex, and other techniques), or other suitable processes. Otherwise, the method proceeds to 190.

If it is determined at 120 that data was identified in the filtering process, the method proceeds to 135 where a score is calculated for each filtered result. In one exemplary embodiment, the score can be based on the data field, the data file, and the data source that was searched. In this exemplary embodiment, a match between a first name field may have a lower score than a match between an identification number data field. In this exemplary embodiment the score can be calculated as:

Score=BL−(dist1*m)
Where: BL=a baseline value (e.g. 100)
dist1=Levenshtein(source_str, result_str)
m=multiplier
source_str=some string, substring or concatenated string from the data source
result_str=some string, substring or concatenated string from the target selected results
   The calculation can vary according to data source, data type, data target and data quality. The multiplier, m, for key criteria, for example a social security number, would be higher than the multiplier used for non-key criteria, for example a zip code. Likewise, instead of using the Levenshtein distance, other suitable functions can be used, such as the Hamming distance algorithm, the Damerau-Levenshtein distance algorithm, or other suitable algorithms. The method then proceeds to 140.

At 140, it is determined whether the filter score exceeds a filter score threshold. The filter score threshold can be set based on the data file, the data source, or other suitable data. If it is determined at 145 that the filter score did not meet or exceed the threshold, the method returns to 125. Otherwise, the method proceeds to 150.

At 150, it is determined whether a single match for the data file has been determined, such as by matching all predetermined data fields from the filter. If it is determined that a single match has been found, the method proceeds to 180 where it is confirmed that the highest filter score has been obtained, and the method proceeds to 198 where notification data of a match is generated and the method then proceeds to 199 and terminates.

If it is determined at 150 that more than one match has been made then the method proceeds to 152 to determine if the highest score exceeds or is equal to some threshold that indicates an exact or near exact match. If it is determined at 152 that a score exceeds or equals some threshold then the method proceeds to 180 where it is confirmed that a match has been obtained, and the method proceeds to 198. If it is determined in 153 that a highest match score has not been obtained, the method proceeds to 155 where the match score is adjusted based on the distribution of match scores.

In one exemplary embodiment, a best score might be a value “X,” and the second best score might be a value “X*0.Y,” where X and Y are integers. As such, the second best score for a first data file might be different for the second best score for a second data file, and adjustment of the match score addresses such variations. The method then proceeds to 160 where the adjusted match scores are filtered. If it is determined at 165 that the results indicate a match, the method proceeds to 180. Otherwise, the method proceeds to 170 where an iteration counter is checked, such as to avoid continued searching for data files that require manual processing. The method proceeds to 172 where a secondary match is performed. The secondary match is based on secondary criteria that can be key or non-key. Key criteria are criteria that are given heavier consideration during scoring than non-key criteria. Secondary criteria vary based on the data sets being matched.

In one exemplary embodiment, a secondary search criterion for an individual can be their date of birth. In another exemplary embodiment, if an initial search for “John Smith” living at an “address X” returns two data records associated with “John Smith” at “address X,” secondary criteria can be used to determine which data record is the correct data record to be associated with the data stream. After a secondary match is performed, the method then proceeds to 175 where a new score is calculated and the iteration counter is incremented if the iteration limit has not been reached, and the method returns to 155. New scores are calculated at 175 according to the type of criteria being used for matching. If the criteria used for matching is key criteria then the score can be calculated as:

Score=Score+k

Where: k=key criteria value

If the criteria used for matching is non-key criteria then the score can be calculated as:

Score=Score+[(edt−dist2)*nkm]

Where: edt=Edit distance threshold
dist2=Levenshtein(source_str,result_str)
nkm=non-key criteria multiplier
source_str=some string, substring or concatenated string from the data source
result_str=some string, substring or concatenated string from the target selected results.
   The values for these parameters—k, edt and nkm—are initialized at 101.

If the iteration limit has been reached, the method proceeds to 190, where notification data that no match has been found is generated. The method then proceeds to 192 where manual review of the data file is performed and new search criteria, filter criteria, or other suitable criteria are implemented based on the manual review, such as to avoid the need for manual processing of future data files. The method then proceeds to 199 and terminates.

In operation, method 300 allows data files to be matched to a data source, such as to facilitate processing claims or for other suitable purposes. Method 300 reduces or eliminates the need for manual processing by using normalized data, predetermined search criteria and filters that can be selected based on the data file being processed or the data source that the data file is being correlated with, or other suitable criteria.

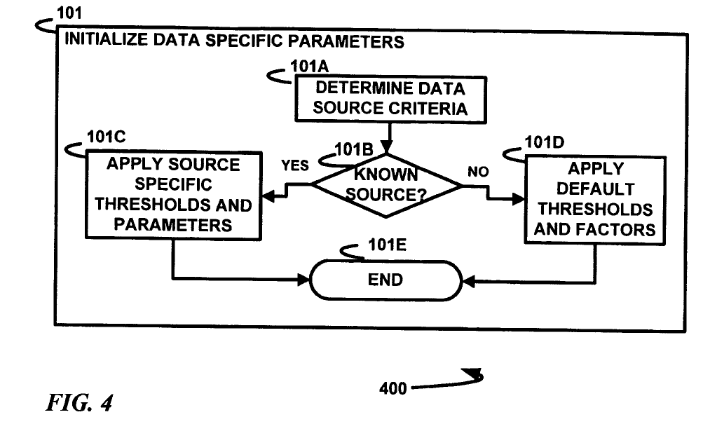

FIG. 4 is a flow chart of a method 400 for setting source and target specific parameters for tuning the matching engine in accordance with an exemplary embodiment of the present invention.

Method 400 can be applied to step 101 of method 300 where source specific parameters are initialized. Data source criteria are determined at 101a using various criteria including but not limited to data type, format, paper, OCR, client, database, and/or EDI. If it is determined that the data source is known or partially known at 101b then thresholds and parameters are applied at 101c that are specific to that data source. If it is determined at 101b that the data source is not known, then default thresholds and parameters are applied at 101d. For example, electronic data sources tend to be more accurate then uncorrected OCR data sources. Once the thresholds and parameters are initialized this operation is completed at 101e, control is returned to the main method, such as method 300. Method 400 allows more stringent criteria to be used for selecting and filtering data sources and data targets to perform matching, in order to limit the number of results thus reducing processing and improving performance.

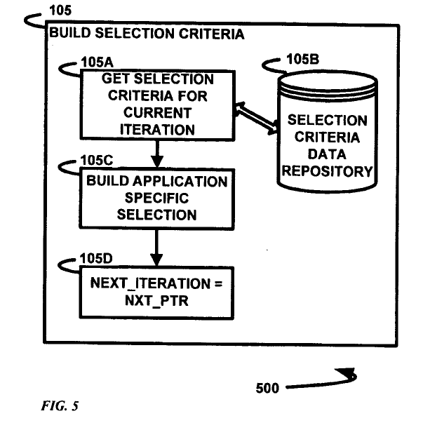

FIG. 5 is a flow chart of a method 500 for building selection criteria in accordance with an exemplary embodiment of the present invention. The selection criteria are determined according to the source and target data set being matched and can be tuned according to but not limited to the application, origination of the source, origination of the target data, quality of the source data, quality of the target data, data type, and other parameters. Selection criteria are retrieved at 105a from selection criteria data repository 105b or suitable locations, such as by using a lookup table, data entry screen, a software coded module, or other suitable processes. The selection criteria are used to build an application specific selection at 105c, such as by using a database select statement or other suitable processes.

The criteria used for selecting and filtering can include a combination of predetermined techniques, functions and conditions, including but not limited to determining whether the source string equals the target string, is greater than the target string, is lesser than the target string, is greater than or equal to the target string, is lesser than or equal to the target string, or other suitable processes. Likewise, the source or target data can be limited to a substring, or other suitable matching processes can be used, such as soundex, Levenshtein, Hamming, Damerau-Levenshtein, or other string matching and data select techniques.

At 105d, the Next_Iteration pointer is incremented for use in determining whether to expand the search, such as at step 125 of method 300, and to point to the next set of selection criteria. The results of determining and building the selection criteria at 105 are forwarded to get data from a data source at 110.

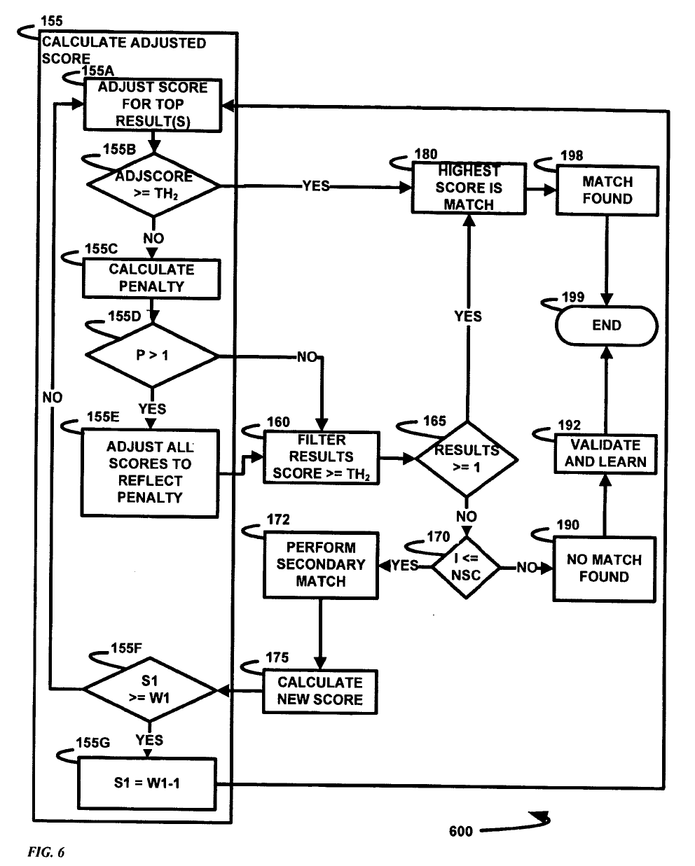

FIG. 6 is a flow chart of a method 600 for adjusting scores based on adjunct criteria in accordance with an exemplary embodiment of the present invention. To determine the best match when there are several candidate scores, the top two scores are adjusted at 155. In one exemplary embodiment, scoring can incorporate a combination of score adjustment at 155a, penalty assessment at 155c, and adjustment at 155e, coupled with performing matching with secondary matching criteria at 172 and associated scoring of secondary matching at 175. The adjusted score determined at 155a can be calculated for the top score or scores using the following formula:

Adjusted_Score=100*(s1−s2)/[(W1−s1)*W2]

Where:
s1=Best Score
s2=Second Best Score
W1=Weighted Value 1
W2=Weighted Value 2

Weighted values W1 and W2 can be initialized at step 101 of method 300 or in other suitable applications and serve multiple purposes. First, the use of W1 and W2 in the divisor ensures that a divide-by-zero error will never occur at 155f or 155g. Secondly, W1 and W2 offer a more flexible and tunable mechanism for scoring.

In one embodiment of this present invention, W1 and W2 can be dynamically assigned and/or reassigned according to the quality and importance of the data being considered. In another exemplary embodiment, where a match is being performed on an input data stream to identify a physician that provided services for a patient, a facility address referring to the “place of service” can be assigned a higher value/weight than a phone number for the physician's office.

Using an earlier example, if two patients having a name of “John Smith” are found, a date of birth (DOB) could be assigned a higher value/weight than an address, such as to identify a potential duplicate record or differentiate between “John Smith Sr.” and “John Smith Jr.” that reside at the same address. In this exemplary embodiment, the patient's address could be assigned a lower value/weight for several reasons, such as because patients are more transient than medical facilities and because multiple John Smith's could live at the same address.

Each adjusted score can be tested at 155b to determine if the newly calculated adjusted score is greater than or equal to TH₂. If the highest adjusted score is greater than or equal to TH₂ then the highest score is a match and the method proceeds to 180.

If it is determined at 155b that the adjusted score is not greater than or equal to TH₂ then a penalty can be calculated at 155c. In one exemplary embodiment, a penalty score can be calculated by:

P=10/(s1−s2+1)

Where:
s1=Best Score
s2=Second Best Score

After the resulting penalty, P, is calculated at 155c, it is determined whether P is greater than 1 at 155d. If P is greater than 1 then all scores to reflect the penalty at 155e, such as by using the following relationship:

Score=Score−P

Where:
P Penalty
s1=Best Score
s2=Second Best Score

If it is determined that P is not greater than 1 at 155d, then the results above the threshold are filtered at 160 and if there are no results, a test is performed for the remaining number of secondary search criteria at 170. If there are additional matching criteria available that can be applied at 170, then a secondary match is performed at 172 and a new score is calculated for each string and or record at 175.

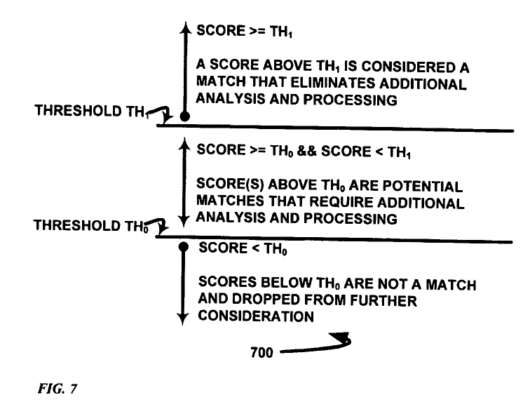

FIG. 7 is a diagram of a method 700 for determining the relationship between thresholds TH₀ and TH₁ in accordance with an exemplary embodiment of the present invention. Thresholds TH₀ and TH₁ are tunable thresholds that provide control of the quality of the matched results, where a higher threshold is used to require a more stringent the match in order to pass the threshold. When working with accurate, high quality data sources and data target sets, the thresholds can be set high to minimize the number of false positives and to allow the system to be tuned for optimal performance.

Threshold TH₁ is a tunable threshold designed to identify an exact match or a match with a very high level of confidence, such as a match that is high enough to consider the match exact and bypass any additional processing. Threshold TH₁ can be the highest threshold, and threshold TH0 can be a secondary threshold designed to identify matches with a high level of confidence but not high enough to conclude a match without additional analysis.

The FIGURES illustrate exemplary embodiments of the present invention, which includes dynamic, flexible and tunable methods and systems for matching a string or strings, such as from a data record, data file, or other association of data from a data source, to a corresponding string or strings in a plurality of data records, data files, or other associations of data in a data target, and accommodates data sources and data targets having less than perfect reliability.

In view of the above detailed description of the present invention and associated drawings, other modifications and variations are apparent to those skilled in the art. It is also apparent that such other modifications and variations may be effected without departing from the spirit and scope of the present invention.

1. A processor-implemented method for correlating data from a data source representing a single data file to a data target containing a plurality of data files, comprising:
normalizing the data from the data source;
determining one or more data strings to use as preliminary selection criteria;
using the preliminary selection criteria to search for one or more matches in the normalized data from the data source using a data processor;
determining one or more data strings to use as secondary selection criteria if no match is found using the preliminary selection criteria; and
calculating a correlation score if at least one match is found using the preliminary selection criteria using the data processor; and
storing the correlation score in a computer-readable memory.

2. The method of claim 1 further comprising determining one or more data strings to use as secondary selection criteria if the correlation score is less than a threshold score.

3. The method of claim 1 further comprising associating data from the data source to one of the data files of the plurality of data files of the data target if the correlation score equals a matching score.

4. The method of claim 2 wherein the threshold score 1S selected based on the data source.

5. The method of claim 2 wherein the threshold score is selected based on the data target.

6. The method of claim 3 wherein the matching score 1S selected based on the data source.

7. The method of claim 3 wherein the matching score 1S selected based on the data target.

8. The method of claim 1 wherein calculating the correlation score if at least one match is found using the preliminary selection criteria comprises determining:
Score=BL−(dist1*m)
where:
BL=a predetermined baseline value
dist1=Levenshtein(source_str, result_str)
m=multiplier based on whether preliminary selection criteria is a key criteria
source_str=data string extracted from source
dataresult str=data string located in target data;
wherein the determining is performed using the data processor.

9. The method of claim 8 further comprising:
determining whether the correlation score is greater than or equal to a predetermined threshold; and
adjusting the correlation score if the correlation score is not greater than or equal to the predetermined threshold.

10. The method of claim 9 wherein adjusting the correlation score if the correlation score is not greater than or equal to the predetermined threshold comprises adding a constant to the score if the matched data string is a key criteria.

11. The method of claim 9 wherein adjusting the correlation score if the correlation score is not greater than or equal to the predetermined threshold comprises determining:
Score=Score+[(edt−dist2)*m]
Where:
edt=predetermined edit distance threshold
dist2=(source_str,result_str)
m=multiplier based on whether secondary selection criteria is a key criteria
source_str=data string extracted from source
dataresult_str=data string located in target data;
wherein the determining is performed using the data processor.

12. A computer-implemented method for correlating data from a data source representing an electronically-stored single data file to a data target containing a plurality of electronically-stored data files, comprising:
normalizing the data from the data source using data processing equipment;
determining one or more data strings that are a first subset of a plurality of data strings to use as preliminary selection criteria using data processing equipment;
using the preliminary selection criteria to search for one or more matches in the normalized data from the data source using data processing equipment;
determining one or more data strings that are a second subset of the plurality of data strings to use as secondary selection criteria using data processing equipment if no match is found using the preliminary selection criteria; and
calculating a correlation score using data processing equipment if at least one match is found using the preliminary selection criteria.

13. The method of claim 12 further comprising determining one or more data strings to use as secondary selection criteria using data processing equipment if the correlation score is less than a threshold score.

14. The method of claim 12 further comprising associating data from the data source to one of the data files of the plurality of data files of the data target using data processing equipment if the correlation score equals a matching score.

15. The method of claim 13 wherein the threshold score is selected based on the data source.

16. The method of claim 13 wherein the threshold score is selected based on the data target.

17. The method of claim 14 wherein the threshold score is selected based on the data source.

18. The method of claim 14 wherein the threshold score is selected based on the data target.

19. The method of claim 12 wherein calculating the correlation score using data processing equipment if at least one match is found using the preliminary selection criteria comprises using data processing equipment to determine a variable score based on the equation:
Score=BL−(dist1*m)
where:
BL=a predetermined baseline value
dist1=Levenshtein(source_str, result_str)
m=multiplier based on whether preliminary selection criteria is a key criteria
source_str=data string extracted from source
dataresult_tr=data string located in target data.

20. A computer-implemented system for correlating data from a data source representing an electronically-stored single data file to a data target containing a plurality of electronically-stored data files, comprising:
means for normalizing the data from the data source;
means for determining one or more data strings to use as preliminary selection criteria;
means for using the preliminary selection criteria to search for one or more matches in the normalized data from the data source;
means for determining one or more data strings to use as secondary selection criteria if no match is found using the preliminary selection criteria; and
means for calculating a correlation score if at least one match is found using the preliminary selection criteria.
